(19) United States
(12) Patent Application Publication
(10) Pub. No.: US 2025/0280318 A1
(43) Pub. Date: Sep. 4, 2025

(54) BEAM REPORT SENDING METHOD AND APPARATUS, BEAM REPORT RECEIVING METHOD AND APPARATUS, AND COMMUNICATION DEVICE

(71) Applicant: VIVO MOBILE COMMUNICATION CO., LTD., Dongguan (CN)

(72) Inventors: Yuan SHI, Dongguan (CN); Peng SUN, Dongguan (CN); Hao WU, Dongguan (CN)

(73) Assignee: VIVO MOBILE COMMUNICATION CO., LTD., Dongguan (CN)

(21) Appl. No.: 19/209,778

(22) Filed: May 15, 2025

Related U.S. Application Data
(63) Continuation of application No. PCT/CN2023/126701, filed on Oct. 26, 2023.

(30) Foreign Application Priority Data
Nov. 16, 2022 (CN) 202211436550.9

(51) Int. Cl. H04W 24/10; H04B 7/08

(52) U.S. Cl. CPC H04W 24/10; H04B 7/088

(57) ABSTRACT

A beam report sending method, a beam report receiving method, and a communication device are provided. The beam report sending method includes: sending, by a terminal, a beam report, the beam report including or being associated with beam combination indication information, the beam combination indication information being used for indicating a target beam combination, and the target beam combination being used for determining at least one of beam quality information, beam information, or artificial intelligence (AI) model monitoring information that are fed back by the beam report.

### CROSS-REFERENCE TO RELATED APPLICATIONS

This application is a continuation of International Application No. PCT/CN2023/126701, filed Oct. 26, 2023, which claims priority to Chinese Patent Application No. 202211436550.9, filed Nov. 16, 2022. The entire contents of each of the above-referenced applications are expressly incorporated herein by reference.

### TECHNICAL FIELD

This application belongs to the field of communication technologies, and specifically relates to a beam report sending method and apparatus, a beam report receiving method and apparatus, and a communication device.

### BACKGROUND

When beam prediction is performed by using an Artificial Intelligence (AI) model, which beam combinations are selected by a terminal for measurement greatly affects accuracy of the beam prediction.

### SUMMARY

Embodiments of this application provide a beam report sending method and apparatus, a beam report receiving method and apparatus, and a communication device.

In a first aspect, a beam report sending method is provided, including:
sending, by a terminal, a beam report, the beam report including or being associated with beam combination indication information, the beam combination indication information being used for indicating a target beam combination, and the target beam combination being used for determining at least one of beam quality information, beam information, or AI model monitoring information that are fed back by the beam report.

In a second aspect, a beam report receiving method is provided, including:
receiving, by a network-side device, abeam report, the beam report including or being associated with beam combination indication information, the beam combination indication information being used for indicating a target beam combination, and the target beam combination being used for determining at least one of beam quality information, beam information, or AI model monitoring information that are fed back by the beam report.

In a third aspect, a beam report sending apparatus is provided, including:
a first sending module, configured to send a beam report, the beam report including or being associated with beam combination indication information, the beam combination indication information being used for indicating a target beam combination, and the target beam combination being used for determining at least one of beam quality information, beam information, or AI model monitoring information that are fed back by the beam report.

In a fourth aspect, a beam report receiving apparatus is provided, including:
a second receiving module, configured to receive a beam report, the beam report including or being associated with beam combination indication information, the beam combination indication information being used for indicating a target beam combination, and the target beam combination being used for determining at least one of beam quality information, beam information, or AI model monitoring information that are fed back by the beam report.

According to a fifth aspect, a communication device is provided, including: a processor, a memory, and a program or an instruction stored in the memory and executable by the processor, where when the program or the instruction is executed by the processor, steps of the method as described in the first aspect or the second aspect are implemented.

In a sixth aspect, a readable storage medium is provided, the readable storage medium having a program or an instruction stored therein, where when the program or the instruction is executed by a processor, steps of the method as described in the first aspect or the second aspect are implemented.

In a seventh aspect, a chip is provided, the chip including a processor and a communication interface, where the communication interface is coupled to the processor, and the processor is configured to run a program or an instruction to implement steps of the method as described in the first aspect or the second aspect.

In an eighth aspect, a computer program/program product is provided, where the computer program/program product is stored in a non-transitory storage medium, and the computer program/program product is executed by at least one processor to implement steps of the method as described in the first aspect or the second aspect.

In a ninth aspect, a communication system is provided, the communication system including a terminal and a network-side device, where the terminal is configured to implement steps of the method as described in the first aspect or the second aspect, and the network-side device is configured to implement steps of the method as described in the first aspect or the second aspect.

In the embodiments of this application, the terminal may feed back beam combination indication information to the network-side device through a beam report. The beam combination indication information can indicate a target beam combination used for determining at least one of beam quality information, beam information, or AI model monitoring information that are fed back by the beam report. In this way, the network-side device may use the target beam combination to perform beam prediction, thereby improving accuracy of the beam prediction.

### BRIEF DESCRIPTION OF THE DRAWINGS

FIG. 1 is a schematic diagram of a neural network;

FIG. 2 is a schematic diagram of neurons;

FIG. 3 is a schematic diagram I of beam prediction based on an AI model;

FIG. 4 is a schematic diagram II of beam prediction based on an AI model;

FIG. 5 is a schematic diagram III of beam prediction based on an AI model;

FIG. 6 is a schematic architectural diagram of a wireless communication system according to an embodiment of this application;

FIG. 7 is a flowchart of a beam report sending method according to an embodiment of this application;

FIG. 8 is a flowchart of a beam report receiving method according to an embodiment of this application;

FIG. 9 is a schematic diagram of a beam report sending apparatus according to an embodiment of this application;

FIG. 10 is a schematic diagram of a beam report receiving apparatus according to an embodiment of this application;

FIG. 11 is a schematic diagram of a terminal according to an embodiment of this application;

FIG. 12 is a schematic diagram of a network-side device according to an embodiment of this application; and

FIG. 13 is a schematic diagram of a communication device according to an embodiment of this application.

### DETAILED DESCRIPTION

The technical solutions in the embodiments of this application are clearly described in the following with reference to the accompanying drawings in the embodiments of this application. Apparently, the described embodiments are merely some of rather than all of the embodiments of this application. Based on the embodiments in this application, all other embodiments obtained by a person of ordinary skill in the art fall within the protection scope of this application.

The terms such as “first” and “second” in the specification and claims of this application are used for distinguishing similar objects, but are not used for describing a specific order or sequence. It will be appreciated that the terms used in this way are exchangeable in a proper case, so that the embodiments of this application can be implemented in an order different from the order shown or described herein, and objects distinguished by “first” and “second” are usually of the same category and the number of the objects is not defined. For example, there may be one or more first objects. In addition, the expression “and/or” in the specification and claims indicates at least one of connected objects, and the character “/” generally indicates that the associated objects are in an “or” relationship. The term “indication” in the specification and claims of this application may be an explicit indication or an implicit indication. The explicit indication may be understood as that a sender explicitly notifies a receiver of an operation that needs to be performed or a request result in a sent indication. The implicit indication may be understood as that the receiver determines according to an indication sent by the sender, and determines, according to a judgment result, an operation that needs to be performed or a request result.

It should be noted that, the technology described in the embodiments of this application is not limited to a Long Term Evolution (LTE)/LTE-Advanced (LTE-A) system, and may be further used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually interchangeably used, and the technologies described may be applied to the systems and radio technologies mentioned above, and may also be applied to other systems and radio technologies. The following description describes a New Radio (NR) system for illustration, and NR terminology is used in most of the following descriptions, but these technologies may also be applied to applications other than NR system applications, such as 6^{th} Generation (6G) communication systems.

To facilitate understanding of implementations of this application, the following technical points will be introduced first:

### 1. Introduction to a Neural Network

At present, artificial intelligence is widely applied in various fields. There are a plurality of implementations of AI modules, such as a neural network, a decision tree, a support vector machine, and a Bayes classifier.

In this application, the neural network is used as an example for description, but a specific type of the AI module is not limited. A structure of the neural network is shown in FIG. 1.

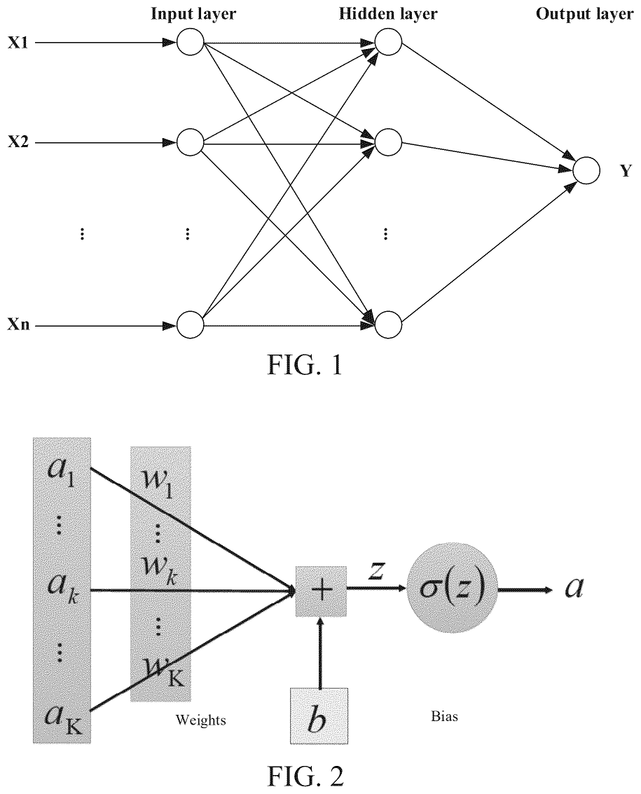

The neural network includes neurons, and a schematic diagram of the neurons is shown in FIG. 2. a₁, a₂, . . . , and σ (·) are inputs, w is a weight (a multiplicative coefficient), b is a bias (an additive coefficient), a (·) is an activation function, and z=a₁w₁+ . . . +aₖwₖ+ . . . +aₖwₖ+b. Common activation functions include a Sigmoid function, a tanh function, a Rectified Linear Unit (ReLU), and the like.

Parameters of the neural network may be optimized by using an optimization algorithm. The optimization algorithm is a type of algorithm that can minimize or maximize an objective function (sometimes also referred to as a loss function). The objective function is usually a mathematical combination of a model parameter and data. For example, by using given data X and a corresponding label Y, a neural network model f(·) is constructed. After the model is constructed, a predicted output f(x) may be obtained based on an input x, and a difference (f(x)−Y) between a predicted value and a true value can be calculated, which is referred to as a loss function. If appropriate W and b are found, a value of the loss function is minimized. A smaller loss value indicates that the model is closer to a real situation.

Currently, common optimization algorithms are basically based on an error back propagation (error Back Propagation, BP) algorithm. A basic idea of the BP algorithm is that a learning process includes two processes: signal forward propagation and error back propagation. During forward propagation, an input sample is transferred from an input layer, undergo processing at each hidden layer, and then are passed to an output layer. If an actual output of the output layer does not match an expected output, a stage of error back propagation is entered. Error back propagation involves propagating an output error back through the hidden layers to the input layer in some forms, and distributing the error among all units at each layer, so as to obtain error signals for the units at each layer. The error signals are then used as a basis for rectifying a weight of each unit. This process of weight adjustment at each layer for signal forward propagation and error backward propagation is performed cyclically. The process of continuously adjusting weights is a learning and training process of the network. This process continues until an error outputted by the network is reduced to an acceptable level or until a preset quantity of learning times is reached.

### 2. About a Beam Indication Mechanism

After beam measurement and beam reporting, the network may perform beam indications on downlink and uplink channels or reference signals, to establish a beam link between the network and the terminal (e.g., a User Equipment (UE)) to implement transmission of the channels or reference signals.

For a beam indication of a physical downlink control channel (PDCCH), the network configures K Transmission Configuration Indication (TCI) states for each Control Resource Set (CORESET) by using Radio resource control (RRC) signaling. When K>1, a Medium Access Control (MAC) Control Element (CE) indicates or activates 1 TCI state. When K=1, no additional MAC CE command is required. When monitoring the PDCCH, the terminal monitors the PDCCH by using same Quasi-colocation (QCL), that is, a same TCI state, for all search spaces in the CORESET. A Reference Signal (RS) (for example, a periodic Channel State Information Reference Signal resource (CSI-RS resource), a semi-persistent CSI-RS resource, a synchronization signal block (Synchronization Signal and PBCH block, SSB), and the like) in the TCI state is spatially QCLed with a Demodulation Reference Signal (DMRS) port of a terminal-specific (UE-specific) PDCCH. The terminal may learn, according to the TCI state, which receive beam is used to receive the PDCCH.

For a beam indication of a PDSCH, the network configures X TCI states by using RRC signaling, then activates 2Y TCI states by using a MAC CE command, and then informs a TCI state by using a Y-bit TCI field of Downlink Control Information (DCI). A reference signal in the TCI state is QCLed with a DMRS port of a physical downlink shared channel (PDSCH) to be scheduled. The UE may learn, according to the TCI state, which receive beam is used to receive the PDSCH.

For a beam indication of a CSI-RS, when a CSI-RS type is a periodic CSI-RS, the network configures QCL information for a CSI-RS resource by using RRC signaling. When the CSI-RS type is a semi-persistent CSI-RS, the network activates a CSI-RS resource from an RRC-configured CSI-RS resource set by using a MAC CE command, to indicate QCL information thereof. When the CSI-RS type is an aperiodic CSI-RS, the network configures QCL for the CSI-RS resource by using RRC signaling, and triggers the CSI-RS by using DCI.

For a beam indication of a Physical Uplink Control Channel (PUCCH), the network uses RRC signaling to configure spatial relation information for each PUCCH resource through a parameter PUCCH-spatial relation information. When a plurality pieces of spatial relation information are configured for the PUCCH resource, one of the plurality of pieces of spatial relation information is indicated or activated by using a MAC CE. When only 1 piece of spatial relation information is configured for the PUCCH resource, no additional MAC CE command is required.

For a beam indication of a PUSCH, spatial relation information of the PUSCH is indicated as follows: When the PUSCH is scheduled by using DCI carried by the PDCCH, each SRI code point of a sounding reference signal resource indicator (Sounding Reference Signal resource indicator, SRI) field in the DCI indicates one SRI. The SRI is used for indicating the spatial relation information of the PUSCH.

For a beam indication of an SRS, when an SRS type is a periodic SRS, the network configures spatial relation information for an SRS resource by using RRC signaling. When the SRS type is a semi-persistent SRS, the network activates one piece in a set of RRC-configured spatial relation information by using a MAC CE command. When the SRS type is an aperiodic SRS, the network configures spatial relation information for the SRS resource by using RRC signaling.

For a further beam indication improvement, a unified Transmission Configuration Indicator (TCI) state is proposed. In short, subsequent beam information of reference signals and a plurality of channels is indicated by using a TCI field in a piece of DCI.

The beam information, spatial relation information, spatial domain transmission filter information, spatial filter information, TCI state information, QCL information, QCL parameters, beam association relationships, and the like have approximately the same meaning.

Downlink beam information may usually be represented by the TCI state information or the QCL information. Uplink beam information may usually be represented by the spatial relation information.

### 3. About Beam Measurement and Beam Reporting

Analog beamforming features transmission at full bandwidth, and array elements of each polarization direction on a panel of each high-frequency antenna array can only transmit analog beams in a time division multiplexing manner. Shaping weights of the analog beams are implemented by adjusting parameters of a device such as a radio-frequency front-end phase shifter.

Currently, in academic community and industry, an analog beamforming vector is usually trained in a polling manner. That is, array elements of each polarization direction of each antenna panel sequentially send training signals (that is, candidate shaping vectors) in a time division multiplexing manner at an appointed time. After measurement, the terminal feeds back a beam report, so that the network side uses the training signal to implement analog beam transmission in a next transmission service. Content of the beam report typically includes identifiers of several optimal transmit beams and measured receive power of each transmit beam.

A quantity of the beam report is determined by using a parameter configured by the network for the terminal. Quantities of RSs and RSRPs that should be included in the beam report of the terminal are configured by using an RRC configuration parameter. Values of the configured quantities are 1, 2, 3, 4, and a default value is 1. In addition, the quantity is limited based on a capability of the terminal, and the terminal may first report a maximum quantity that can be supported.

When the beam report of the terminal includes only one Layer 1 reference signal received power (L1-RSRP), a 7-bit quantization method is used, with a quantization step of 1 dB and a quantization range of −140 dBm to −44 dBm. When the indicated beam report of the terminal includes a plurality of L1-RSRPs, or a group based beam report is enabled, the strongest RSRP is quantized by using 7-bit quantization, and the remaining RSRPs are quantized by using a 4-bit differential quantization method, with a quantization step of 2 dB.

### 4. About Beam Prediction by Using an AI Method

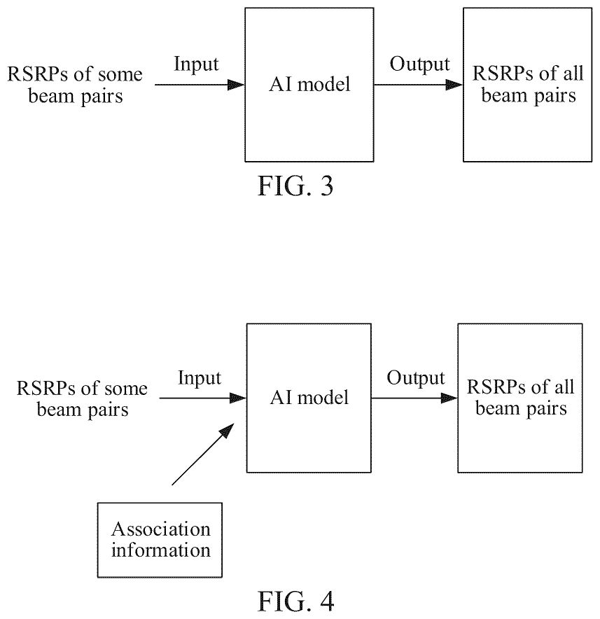

A manner is shown in FIG. 3. RSRPs of some beam pairs are used as inputs, and outputs of an AI model are RSRP results of all the beam pairs. A beam pair includes a transmit beam and a receive beam. Then, an input quantity of the AI model is a quantity of the selected some beam pairs, and an output quantity is a quantity of all the beam pairs.

A method for additionally enhancing performance of beam prediction is shown in FIG. 4.

Association information is added on an input side. The association information is generally angle-related information, beam identity (ID) information, and the like corresponding to a beam pair selected for input. Therefore, the input quantity of the model is still related to the quantity of the selected some beam pairs, and the output quantity is still equal to the quantity of all the beam pairs.

A method for additionally enhancing performance of beam prediction is shown in FIG. 4.

Association information is added on an input side. The association information is generally angle-related information, beam identity (ID) information, and the like corresponding to a beam pair selected for input. Therefore, the input quantity of the model is still related to the quantity of the selected some beam pairs, and the output quantity is still equal to the quantity of all the beam pairs.

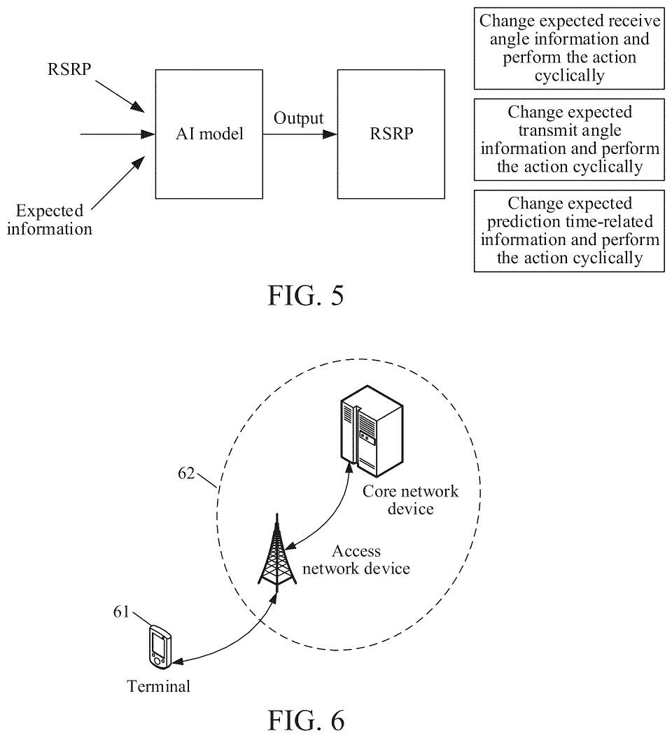

Still another method based on the foregoing improvements is shown in FIG. 5.

The output of the AI model is affected mainly by changing expected information by using the AI model.

An input type of the AI model includes at least one of the following:
(1) beam quality-related information;
(2) beam information;
(3) transmit beam information at an end A;
(4) receive beam information at an end B;
(5) beam information expected by the end B;
(6) receive beam information at the end B and expected by the end B;
(7) transmit beam information at the end A and expected by the end B;
(8) time-related information of beam quality-related information; or
(9) expected prediction time-related information.

The beam quality information herein includes, but is not limited to, at least one of the following types: a Layer 1 signal-to-noise and interference ratio (L1-SINR), Layer 1 reference signal received power (L1-RSRP), Layer 1 reference signal received quality (L1-RSRQ), a Layer 3 signal-to-noise and interference ratio (L3-SINR), Layer 3 reference signal received power (L3-RSRP), Layer 3 reference signal received quality (L3-RSRQ), or the like.

The beam information herein refers to association information corresponding to the beam quality information included in the beam report, and the association information includes, but is not limited to, at least one of the following: beam ID information, beam angle information, beam gain information, beam width information, expected information, or the like.

The beam ID information is used for representing identity recognition-related information of the beam, including, but not limited to, at least one of the following: a transmit beam ID, a receive beam ID, a beam ID, a reference signal set ID corresponding to the beam, a reference signal resource ID corresponding to the beam, a unique identifier random ID, an encoded value after processing by an additional AI network, beam angle information, resource index information, a channel state information reference signal resource indicator (CSI-RS Resource Indicator, CRI), a synchronization signal block resource indicator (SS/PBCH Block Resource Indicator, SSBRI), or the like.

The beam angle information is used for representing angle information corresponding to the beam, including, but not limited to, at least one of the following: angle-related information, transmit angle-related information, or receive angle-related information.

The angle information is used for representing angle or identity-related information, for example, an angle, a radian, an index coded value, an ID value, an encoded value after processing by an additional AI network, and the like.

### 5. About Beam Report and Beam Resource Configuration

Association relationships are as follows: a beam report configuration is associated with a resource configuration, the resource configuration is associated with a beam resource set, and the beam resource set configuration is associated with a beam resource configuration.

For example, a CSI report configuration (CSI-ReportConfig) is associated with a CSI resource configuration (CSI-ResourceConfig), and the CSI-ResourceConfig is associated with a resource set and a time-domain behavior.

(1) If the CSI-RS resource set is used, which corresponds to a Non-Zero Power (NZP)-CSI-RS-Resource Set, an NZP-CSI-RS-Resource is associated in the Resource Set, and the time-domain behavior is used for indicating a time-domain periodicity attribute associated with the CSI-RS resource set.

(2) If an SSB resource set is used, which corresponds to a CSI-SSB-Resource Set, an SSB index is associated in the Resource Set, and in this case, the time-domain behavior is invalid.

One CSI-ReportConfig (e.g., beam report configuration) includes at most three CSI-ResoureConfigs (e.g., beam resource configurations), and a specific relationship is as follows:

(1) An aperiodic CSI-ReportConifg may be associated with periodic, semi-persistent, and aperiodic CSI-ResourceConfig, and at most 3 beam resource configurations may be configured.

(a) When 1 CSI-ResourceConfig is configured, the CSI-ResourceConfig is used for Channel Measurement (CM), including, for example, L1-RSRP measurement.

(b) 2 CSI-ResourceConfigs are configured. The first one is used for CM, and the second one is used for Interference Measurement (IM). For example, the second one is used for interference measurement on a zero-power resource.

(c) 3 CSI-ResourceConfigs are configured. The first one is used for CM, the second one is used for IM, for example, the second one is used for interference measurement on a zero-power resource, and the third one is used for interference measurement, for example, the third one is used for interference measurement on a zero-power resource.

(2) A semi-persistent CSI-ReportConifg may be associated with a periodic and semi-persistent CSI-ResourceConfig, and at most 2 beam resource configurations may be configured.

(a) 1 CSI-ResourceConfig is used for CM channel measurement, including, for example, L1-RSRP measurement.

(b) 2 CSI-ResourceConfigs are configured. The first one is used for CM, and the second one is used for IM. For example, the second one is used for interference measurement on a zero-power resource.

(3) A periodic CSI-ReportConifg may be associated with a periodic and semi-persistent CSI-ResourceConfig, and at most 2 beam resource configurations may be configured.

(a) 1 CSI-ResourceConfig is used for CM channel measurement, including, for example, L1-RSRP measurement.

(b) 2 CSI-ResourceConfigs are configured. The first one is used for CM, and the second one is used for IM. For example, the second one is used for interference measurement on a zero-power resource.

Time-domain behaviors of 1 or more CSI-ResourceConfigs associated with the CSI-ReportConfig are consistent.

Only 1 Resource set is supported in the periodic and semi-persistent CSI resourceConfig. However, if group-based beam reporting (groupBasedbeamReporting) is supported in a report, 2 sets may be configured.

An aperiodic CSI resourceConfig is not limited to 1 set, and at most 16 sets may be configured.

At most 64 NZP CSI-RS resources are supported in one CSI-RS resource set. When a quantity of reports (reportQuantity)=‘none’, ‘cri-RI-CQI’, ‘cri-RSRP’, or ‘ssb-Index-RSRP’, all the CSI-RS resource sets support at most 128 resources in total.

If information about repetition associated with a CSI-RS resource set is configured to be on, the UE may assume that all CSI-RS resources in the CSI-RS resource set use same transmit beam information during transmission. If the information is configured to be off, the UE may not assume that these resources use the same transmission beam information. That is, a repetition parameter in the CSI-RS resource set may control beam information attributes of all resources associated with the resource set.

In a related technology, when some beams are used for beam prediction, which beam combinations are selected and how the beam combinations are selected greatly affect prediction performance. Therefore, if the AI model is obtained through training on the UE side, the network-side device cannot obtain a performance difference between different beam combinations of the AI model on the UE side. Secondly, if the AI model is trained by the network-side device, the network-side device may learn which beam combinations may help the model performance. However, when an overall network environment, resource scheduling, interference management, and other behaviors are considered, the network-side device needs to adjust measurement resources of the UE.

FIG. 6 is a block diagram of a wireless communication system to which embodiments of this application are applicable. The wireless communication system includes a terminal 61 and a network-side device 62. The wireless communication system may be a communication system having a wireless AI function, such as 5G-Advanced or 6G.

The terminal 61 may be a mobile phone, a tablet personal computer, a laptop computer or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device having a wireless communication function, such as a refrigerator, a television, a washing machine, or furniture), a game console, a personal computer (PC), a teller machine or a self-service machine, and other terminal-side devices. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wrist strap, a smart dress, and the like. In addition to the above terminal devices, the terminal as referred to in this application may also be a chip within a terminal, such as a modem chip or a system on chip (SoC). It is to be noted that, a specific type of the terminal 61 is not limited in this embodiment of this application.

The network-side device 62 may include an access network device or a core network device. The access network device may be referred to as a radio access network device, a Radio Access Network (RAN), a radio access network function, or a radio access network unit. The access network device may include a base station, a Wireless Local Area Networks (WLAN) access point, a Wireless Fidelity (WiFi) node, or the like. The base station may be referred to as a node B, an evolved Node B (eNB), an access point, a Base Transceiver Station (BTS), a radio base station, a radio transceiver, a Basic Service Set (BSS), an Extended Service Set (ESS), a home node B, a home evolved node B, a Transmitting Receiving Point (TRP), or other appropriate terms in the art. As long as a same technical effect is achieved, the base station is not limited to a specific technical term. It is to be noted that, in the embodiments of this application, the base station in an NR system is used only as an example for description, but a specific type of the base station is not limited.

The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), Centralized network configuration (CNC), a Network Repository Function (NRF), a Network Exposure Function (NEF), local NEF (Local NEF or L-NEF), a Binding Support Function (BSF), an Application Function (AF), or the like. It is to be noted that, in the embodiments of this application, the core network device in the NR system is used only as an example for description, but a specific type of the core network device is not limited.

A beam report sending method and apparatus, abeam report receiving method and apparatus, a communication device, and a readable storage medium according to embodiments of this application will be described in detail below in conjunction with the accompanying drawings by using some embodiments and application scenarios thereof.

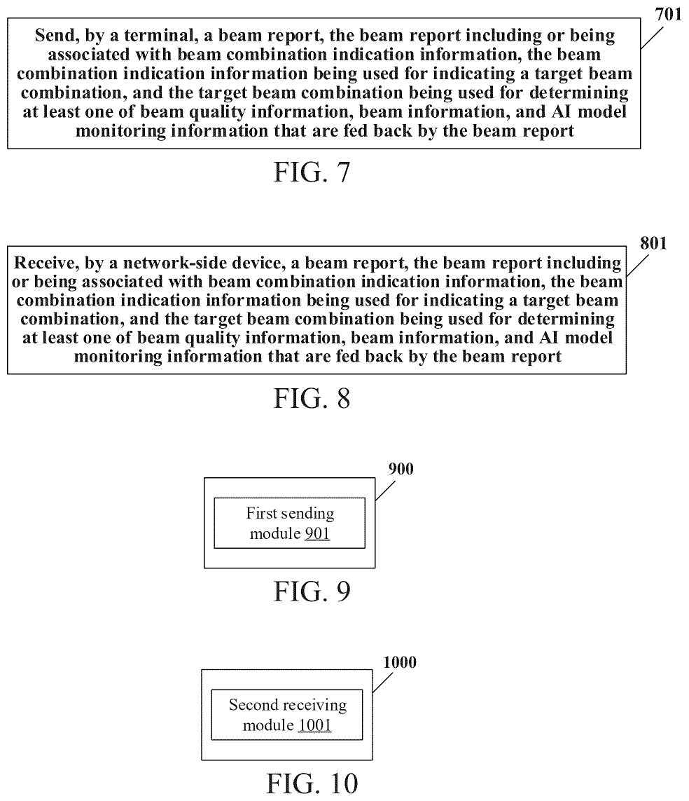

Referring to FIG. 7, an embodiment of this application provides abeam report sending method applied to a terminal, including: step 701.

Step 701: Send, by a terminal, a beam report, the beam report including or being associated with beam combination indication information, the beam combination indication information being used for indicating a target beam combination, and the target beam combination being used for determining at least one of beam quality information, beam information, or AI model monitoring information that are fed back by the beam report.

That is, the beam combination indication information is used for indicating which beam combination determines the beam quality information, the beam information, and the AI model monitoring information that are fed back by the beam report.

The beam report herein may also be referred to as a beam quality information feedback report.

The beam combination herein includes a beam resource combination and/or a beam information combination.

The AI model monitoring information herein is used for representing prediction performance of the AI model, which may be, for example, an indicator such as a beam prediction accuracy rate or beam prediction accuracy, and is not limited thereto.

In this embodiment, at least one of the beam quality information, the beam information, or the AI model monitoring information may be used as input information of training and/or prediction of the AI model.

In this embodiment, at least one of the beam quality information, the beam information, or the AI model monitoring information may be used for beam prediction or adjusting a resource for performing beam measurement by the terminal.

In an implementation of this application, the method further includes:
acquiring, by the terminal, a first beam combination, the first beam combination including M beam combinations or N activated beam combinations, M being an integer greater than or equal to 1, and N being an integer greater than or equal to 0.

The N activated beam combinations may be activated beam combinations in the M beam combinations.

In this embodiment, the target beam combination may be one or more beam combinations in the first beam combination, for example, one or more of the M beam combinations, or one or more of the N activated beam combinations.

In an implementation of this application, the acquiring, by the terminal, a first beam combination includes at least one of the following:

(1) The terminal acquires configuration information of the beam report, the configuration information being associated with or including the first beam combination.

That is, the first beam combination may be associated with or included in configuration information of the beam report, and the configuration information is used for indicating configuration information of a beam quality information feedback report of the terminal.

(2) The terminal receives first information, the first information being associated with or including the first beam combination, and the first information being information other than the configuration information of the beam report.

That is, the terminal may acquire the first beam combination through another additional indication other than the configuration information of the beam report.

In an implementation of this application, the method further includes: receiving, by the terminal, second information;
where the second information is used for at least one of the following:
(1) activating or deactivating at least some beam combinations in the first beam combination; or
(2) activating or deactivating some beam information and/or beam resources in at least some beam combinations in the first beam combination.

In some embodiments, the second information may be a MAC CE or a DCI, and is not limited thereto.

In an implementation of this application, an overhead of the second information is determined by M or N.

In an implementation of this application, the second information includes M or N. For example, the second information includes bitmap information with a length of M or N.

In another implementation of this application, an overhead of x pieces of indication information in the second information are equal to ceiling of log 2(M), where x is a quantity of activated beam combinations from the M beam combinations; or the overhead of the x pieces of indication information in the second information are equal to ceiling of log 2(N), where x is a quantity of deactivated beam combinations from the N beam combinations.

In an implementation of this application, when the configuration information of the beam report is associated with an aperiodic time-domain characteristic, the configuration information of the beam report is associated with a first trigger state, the first trigger state is associated with one or more beam combinations in the first beam combination, and the one or more beam combinations are simultaneously activated when the first trigger state is triggered.

For example, the first beam combination includes a beam combination 1, a beam combination 2, a beam combination 3, a beam combination 4, and a beam combination 5. A trigger state 1 is associated with the beam combination 1 and the beam combination 2, a trigger state 2 is associated with the beam combination 3 and the beam combination 4, and a trigger state 3 is associated with the beam combination 5. In this way, which beam combinations are activated may be determined according to the trigger states. For example, the first trigger state includes the trigger state 1, when the trigger state 1 is triggered, the beam combination 1 and the beam combination 2 are simultaneously activated, or the first trigger state includes the trigger state 1 and the trigger state 3, and when the trigger state 1 and the trigger state 3 are triggered, the beam combination 1, the beam combination 2, and the beam combination 5 are simultaneously activated.

In an implementation of this application, an overhead of the beam combination indication information is determined by M or N.

For example, the overhead of the beam combination indication information is determined by using the following formula: ceiling of log 2(M or N).

In an implementation of this application, the beam report satisfies one of the following:

(1) The beam report includes or is associated with one piece of beam combination indication information, and the beam combination indication information corresponds to one piece of time information or corresponds to one piece of AI model monitoring information.

(2) The beam report includes or is associated with a plurality of pieces of beam combination indication information, each piece of beam combination indication information corresponds to one piece of time information or corresponding to one piece of AI model monitoring information, and the time information is used for indicating a time-domain position or periodic position of the beam indication information.

The time information herein may also be referred to as timestamp information.

(3) The beam report includes or is associated with one piece of beam combination indication information, the one piece of beam combination indication information includes bitmap information, the bitmap information includes at least one bit, and each bit corresponds to AI model monitoring information of a beam combination.

For example, the network configures M beam combinations, the beam report includes or is associated with one piece of beam combination indication information, and the one piece of beam combination indication information corresponds to AI model monitoring information of the M beam combinations. For example, the beam combination indication information may be bitmap information, and each bit in the bitmap information may correspond to AI model monitoring information of a beam combination. In some embodiments, the bits in the bitmap information have a preset correspondence with the beam combinations in the M beam combinations. For example, a first bit in the bitmap information corresponds to a first beam combination in the M beam combinations, a second bit in the bitmap information corresponds to a second beam combination in the M beam combinations, and the rest may be deduced by analogy. In some embodiments, the last bit in the bitmap information corresponds to the first beam combination in the M beam combinations, the second-to-last bit in the bitmap information corresponds to the second beam combination in the M beam combinations, and the rest may be deduced by analogy.

(4) The beam report includes or is associated with one piece of beam combination indication information, and the one piece of beam combination indication information corresponds to at least one piece of AI model monitoring information.

In some embodiments, a quantity of “at least one piece of AI model monitoring information” corresponding to one piece of beam combination indication information is equal to a quantity of enabled beam combinations indicated in the one piece of beam combination indication information.

For example, the network configures M beam combinations, and the beam report includes or is associated with one piece of beam combination indication information. The beam combination indication information may be bitmap information having a length of M. Each bit is used for indicating whether a beam combination at a corresponding position is indicated, “1” represents that a beam combination corresponding to the position is selected, and “0” represents that a beam combination corresponding to the position is not selected. The beam report includes bit positions having a length of M, including M1 enabled positions and corresponding to M1 pieces of AI model monitoring information.

(5) The beam report includes or is associated with at least one piece of beam combination indication information and at least one piece of AI model monitoring information, and one piece of beam combination indication information corresponds to one piece of AI model monitoring information.

For example, the network configures M beam combinations, the beam report includes or is associated with one piece of AI model monitoring information, the one piece of AI model monitoring information corresponds to a model monitoring result of one beam combination, and the model monitoring result of the one beam combination corresponds to a best model monitoring result in the M beam combinations.

(6) The beam report includes or is associated with at least one piece of AI model monitoring information, and one piece of AI model monitoring information corresponds to one or more pieces of beam combination indication information.

For example, the network configures M beam combinations, the beam report includes or is associated with one piece of AI model monitoring information, and the one piece of AI model monitoring information corresponds to AI model monitoring information of the M beam combinations.

In another example, the network configures M beam combinations, the beam report including or being associated with M pieces of AI model monitoring information, and the M pieces of AI model monitoring information are in one-to-one correspondence to model monitoring information of the M beam combinations. In this case, the beam report may not include the beam combination indication information.

(7) The beam report includes bitmap information, the bitmap information includes at least one bit, and each bit corresponds to one piece of beam indication information.

For example, the beam report includes bitmap information with a length of M or N, and each bit in the bitmap information corresponds to one piece of beam indication information.

The AI model monitoring information is used for indicating overall performance of one or more beam combinations indicated by the one or more pieces of beam combination indication information associated therewith. The AI model monitoring information herein may also be referred to as an AI model monitoring result.

In an implementation of this application, when M or N is equal to 1, the beam report does not include the beam combination indication information.

That is, if the network-side device configures 1 beam combination, the beam report does not need to include the beam combination indication information.

In an implementation of this application, in a case that a quantity of the AI model monitoring information may be consistent with a quantity of beam combinations in the first beam combination, that is, one piece of AI model monitoring information is in one-to-one correspondence to one beam combination in the first beam combination, the beam report may not include the beam combination indication information.

In an implementation of this application, the configuration information being associated with or including the first beam combination includes: the configuration information being associated with or including a complete set of the first beam combination.

In an implementation of this application, the first information being associated with or including the first beam combination includes: the first information being associated with or including the complete set of the first beam combination.

For example, the M beam combinations or the N activated beam combinations may partially overlap. The network-side device does not need to configure the M beam combinations or the N activated beam combinations. The network-side device only needs to configure a complete set of the M beam combinations or the N activated beam combinations, provided that the complete set includes the M beam combinations or the N activated beam combinations. The terminal may measure only the complete set during measurement.

In another example, the M beam combinations or the N activated beam combinations may partially overlap. The network-side device configures the M beam combinations or the N activated beam combinations, and the terminal measures only a complete set of the M or N beam combinations during measurement. That is, overlapped beam resources and/or resources corresponding to the beam information are measured only once.

In an implementation of this application, the method further includes:
performing, by the terminal, beam measurement on a target beam combination, the target beam combination being a complete set of the first beam combination.

In an implementation of this application, at least one different beam resource and/or beam information exist/exists between different beam combinations in the first beam combination.

In an implementation of this application, the method further includes:
sending, by the terminal, information of a second beam combination, the second beam combination satisfying one of the following:
(1) the first beam combination being a subset of the second beam combination;
(2) some beam combinations in the second beam combination being the same as some beam combinations in the first beam combination; or
(3) the second beam combination being used by a network-side device to configure the first beam combination.

For example, the second beam combination includes K beam combinations, where K is an integer greater than or equal to 1, and the M beam combinations or the N activated beam combinations are a subset of the K beam combinations.

In this embodiment of this application, the terminal may feed back beam combination indication information to the network-side device through a beam report. The beam combination indication information can indicate a target beam combination used for determining at least one of beam quality information, beam information, or AI model monitoring information that are fed back by the beam report. In this way, the network-side device may use the target beam combination to perform beam prediction, thereby improving accuracy of the beam prediction, or the network-side device may use the target beam combination to adjust resources used for beam measurement, thereby improving flexibility of the network side.

Referring to FIG. 8, an embodiment of this application provides abeam report receiving method applied to a network-side device, including: step 801.

Step 801: Receive, by a network-side device, a beam report, the beam report including or being associated with beam combination indication information, the beam combination indication information being used for indicating a target beam combination, and the target beam combination being used for determining at least one of beam quality information, beam information, or AI model monitoring information that are fed back by the beam report.

In an implementation of this application, the method further includes:
performing, by the network-side device according to the target beam combination, beam prediction or adjusting resources used for beam measurement.

In an implementation of this application, the method further includes:
configuring, by the network-side device, a first beam combination for a terminal, the first beam combination including M beam combinations or N activated beam combinations, M being an integer greater than or equal to 1, and N being an integer greater than or equal to 0.

In an implementation of this application, the configuring, by the network-side device, a first beam combination for a terminal includes at least one of the following:
sending, by the network-side device, configuration information of the beam report to the terminal, the configuration information being associated with or including the first beam combination; or
sending, by the network-side device, first information to the terminal, the first information being associated with or including the first beam combination, and the first information being information other than the configuration information of the beam report.

In an implementation of this application, the method further includes: sending, by the network-side device, second information;
where the second information is used for at least one of the following:
activating or deactivating at least some beam combinations in the first beam combination; or
activating or deactivating some beam information and/or beam resources in at least some beam combinations in the first beam combination.

In an implementation of this application, in a case that the first beam combination includes M beam combinations, an overhead of information used for activating or deactivating a beam combination is determined by M.

In an implementation of this application, when the configuration information of the beam report is associated with an aperiodic time-domain characteristic, the configuration information of the beam report is associated with a first trigger state, the first trigger state is associated with one or more beam combinations in the first beam combination, and the one or more beam combinations are simultaneously activated when the first trigger state is triggered.

In an implementation of this application, the beam report satisfies one of the following:
(1) the beam report including or being associated with one piece of beam combination indication information, the beam combination indication information corresponding to one piece of time information or corresponding to one piece of AI model monitoring information;
(2) the beam report including or being associated with a plurality of pieces of beam combination indication information, each piece of beam combination indication information corresponding to one piece of time information or corresponding to one piece of AI model monitoring information, and the time information being used for indicating a time-domain position or periodic position of the beam indication information;
(3) the beam report including or being associated with one piece of beam combination indication information, the beam combination indication information including bitmap information, the bitmap information including at least one bit, and each bit corresponding to AI model monitoring information of a beam combination;
(4) the beam report including or being associated with one piece of beam combination indication information, the beam combination indication information corresponding to at least one piece of AI model monitoring information;
(5) the beam report including or being associated with at least one piece of beam combination indication information and at least one piece of AI model monitoring information, one piece of beam combination indication information corresponding to one piece of AI model monitoring information;
(6) the beam report including or being associated with at least one piece of AI model monitoring information, one piece of AI model monitoring information corresponding to one or more pieces of beam combination indication information; or
(7) the beam report including bitmap information, the bitmap information including at least one bit, and each bit corresponding to one piece of beam indication information.

For example, the beam report includes bitmap information with a length of M or N, and each bit in the bitmap information corresponds to one piece of beam indication information.

The AI model monitoring information is used for indicating overall performance of one or more beam combinations indicated by the one or more pieces of beam combination indication information associated therewith.

In an implementation of this application, when M or N is equal to 1, the beam report does not include the beam combination indication information.

In an implementation of this application, the configuration information being associated with or including the first beam combination includes: the configuration information being associated with or including a combined complete set of the first beam combination;
or
the first information being associated with or including the first beam combination includes: the first information being associated with or including a complete set of the first beam combination.

In an implementation of this application, at least one different beam resource and/or beam information exist/exists between different beam combinations in the first beam combination.

In an implementation of this application, the method further includes:
receiving, by the network-side device, information of a second beam combination, the second beam combination satisfying one of the following:
(1) the first beam combination being a subset of the second beam combination;
(2) some beam combinations in the second beam combination being the same as some beam combinations in the first beam combination; or
(3) the second beam combination being used by a network-side device to configure the first beam combination.

In this embodiment of this application, the network-side device may acquire, through a beam report, beam combination indication information fed back by the terminal.

The beam combination indication information can indicate a target beam combination used for determining at least one of beam quality information, beam information, or AI model monitoring information that are fed back by the beam report. In this way, the network-side device may use the target beam combination to perform beam prediction, thereby improving accuracy of the beam prediction, or the network-side device may use the target beam combination to adjust resources used for beam measurement, thereby improving flexibility of the network side.

Referring to FIG. 9, an embodiment of this application provides abeam report sending apparatus applied to a terminal. An apparatus 900 includes:
a first sending module 901, configured to send abeam report, the beam report including or being associated with beam combination indication information, the beam combination indication information being used for indicating a target beam combination, and the target beam combination being used for determining at least one of beam quality information, beam information, or AI model monitoring information that are fed back by the beam report.

In an implementation of this application, the apparatus further includes:
a first acquisition module, configured to acquire a first beam combination, the first beam combination including M beam combinations or N activated beam combinations, M being an integer greater than or equal to 1, and N being an integer greater than or equal to 0.

In an implementation of this application, the first acquisition module is further configured to perform at least one of the following:
(1) acquiring configuration information of the beam report, the configuration information being associated with or including the first beam combination; or
(2) receiving first information, the first information being associated with or including the first beam combination, and the first information being information other than the configuration information of the beam report.

In an implementation of this application, the apparatus further includes:
a first receiving module, configured to receive second information;
where the second information is used for at least one of the following:
(1) activating or deactivating at least some beam combinations in the first beam combination; or
(2) activating or deactivating some beam information and/or beam resources in at least some beam combinations in the first beam combination.

In an implementation of this application, an overhead of information used for activating or deactivating a beam combination in the second information is determined by M or N.

In an implementation of this application, the second information includes M or N.

In an implementation of this application, when the configuration information of the beam report is associated with an aperiodic time-domain characteristic, the configuration information of the beam report is associated with a first trigger state, the first trigger state is associated with one or more beam combinations in the first beam combination, and the one or more beam combinations are simultaneously activated when the first trigger state is triggered.

In an implementation of this application, an overhead of the beam combination indication information is determined by M or N.

In an implementation of this application, the beam report satisfies one of the following:
(1) the beam report including or being associated with one piece of beam combination indication information, the beam combination indication information corresponding to one piece of time information or corresponding to one piece of AI model monitoring information;
(2) the beam report including or being associated with a plurality of pieces of beam combination indication information, each piece of beam combination indication information corresponding to one piece of time information or corresponding to one piece of AI model monitoring information, and the time information being used for indicating a time-domain position or periodic position of the beam indication information;
(3) the beam report including or being associated with one piece of beam combination indication information, the beam combination indication information including bitmap information, the bitmap information including at least one bit, and each bit corresponding to AI model monitoring information of a beam combination;
(4) the beam report including or being associated with one piece of beam combination indication information, the beam combination indication information corresponding to at least one piece of AI model monitoring information;
(5) the beam report including or being associated with at least one piece of beam combination indication information and at least one piece of AI model monitoring information, one piece of beam combination indication information corresponding to one piece of AI model monitoring information;
(6) the beam report including or being associated with at least one piece of AI model monitoring information, one piece of AI model monitoring information corresponding to one or more pieces of beam combination indication information; or
(7) the beam report including bitmap information, the bitmap information including at least one bit, and each bit corresponding to one piece of beam indication information.

The AI model monitoring information is used for indicating overall performance of one or more beam combinations indicated by the one or more pieces of beam combination indication information associated therewith.

In an implementation of this application, when M or N is equal to 1, the beam report does not include the beam combination indication information.

In an implementation of this application, the configuration information being associated with or including the first beam combination includes: the configuration information being associated with or including a complete set of the first beam combination; or the first information being associated with or including the first beam combination includes: the first information being associated with or including the complete set of the first beam combination.

In an implementation of this application, the apparatus further includes:
a measurement module, configured to perform beam measurement on a target beam combination, the target beam combination being a complete set of the first beam combination.

In an implementation of this application, at least one different beam resource and/or beam information exist/exists between different beam combinations in the first beam combination.

In an implementation of this application, the apparatus further includes:
a second sending module, configured to send information of a second beam combination, the second beam combination satisfying one of the following:
(1) the first beam combination being a subset of the second beam combination;
(2) some beam combinations in the second beam combination being the same as some beam combinations in the first beam combination; or
(3) the second beam combination being used by a network-side device to configure the first beam combination.

The apparatus provided in this embodiment of this application can implement the processes implemented in the method embodiment in FIG. 7 and achieve a same technical effect. To avoid repetition, details are not described herein again.

Referring to FIG. 10, an embodiment of this application provides a beam report receiving apparatus applied to a network-side device. An apparatus 1000 includes:
a second receiving module 1001, configured to receive a beam report, the beam report including or being associated with beam combination indication information, the beam combination indication information being used for indicating a target beam combination, and the target beam combination being used for determining at least one of beam quality information, beam information, or AI model monitoring information that are fed back by the beam report.

In an implementation of this application, the apparatus further includes:
a configuration module, configured to configure a first beam combination for the terminal, the first beam combination including M beam combinations or N activated beam combinations, M being an integer greater than or equal to 1, and N being an integer greater than or equal to 0.

In an implementation of this application, the configuration module is further configured to perform at least one of the following:
sending configuration information of the beam report to the terminal, the configuration information being associated with or including the first beam combination; or
sending first information to the terminal, the first information being associated with or including the first beam combination, and the first information being information other than the configuration information of the beam report.

In an implementation of this application, the apparatus further includes:
a third sending module, configured to send second information, the second information being used for at least one of the following:
activating or deactivating at least some beam combinations in the first beam combination; or
activating or deactivating some beam information and/or beam resources in at least some beam combinations in the first beam combination.

In an implementation of this application, in a case that the first beam combination includes M beam combinations, an overhead of information used for activating or deactivating a beam combination in the second information is determined by M.

In an implementation of this application, when the configuration information of the beam report is associated with an aperiodic time-domain characteristic, the configuration information of the beam report is associated with a first trigger state, the first trigger state is associated with one or more beam combinations in the first beam combination, and the one or more beam combinations are simultaneously activated when the first trigger state is triggered.

In an implementation of this application, the beam report satisfies one of the following:
(1) the beam report including or being associated with one piece of beam combination indication information, the one piece of beam combination indication information corresponding to one piece of time information or corresponding to one piece of AI model monitoring information;
(2) the beam report including or being associated with a plurality of pieces of beam combination indication information, each piece of beam combination indication information corresponding to one piece of time information or corresponding to one piece of AI model monitoring information, and the time information being used for indicating a time-domain position or periodic position of the beam indication information;
(3) the beam report including or being associated with one piece of beam combination indication information, the beam combination indication information including bitmap information, the bitmap information including at least one bit, and each bit corresponding to AI model monitoring information of a beam combination;
(4) the beam report including or being associated with one piece of beam combination indication information, the piece of beam combination indication information corresponding to at least one piece of AI model monitoring information;
(5) the beam report including or being associated with at least one piece of beam combination indication information and at least one piece of AI model monitoring information, one piece of beam combination indication information corresponding to one piece of AI model monitoring information;
(6) the beam report including or being associated with at least one piece of AI model monitoring information, one piece of AI model monitoring information corresponding to one or more pieces of beam combination indication information; or
(7) the beam report including bitmap information, the bitmap information including at least one bit, and each bit corresponding to one piece of beam indication information.

The AI model monitoring information is used for indicating overall performance of one or more beam combinations indicated by the one or more pieces of beam combination indication information associated therewith.

In an implementation of this application, when M or N is equal to 1, the beam report does not include the beam combination indication information.

In an implementation of this application, the configuration information being associated with or including the first beam combination includes: the configuration information being associated with or including a combined complete set of the first beam combination;
or
the first information being associated with or including the first beam combination includes: the first information being associated with or including a complete set of the first beam combination.

In an implementation of this application, at least one different beam resource and/or beam information exist/exists between different beam combinations in the first beam combination.

In an implementation of this application, the apparatus further includes:
a third receiving module, configured to receive information of a second beam combination, the second beam combination satisfying one of the following:
(1) the first beam combination being a subset of the second beam combination;
(2) some beam combinations in the second beam combination being the same as some beam combinations in the first beam combination; or
(3) the second beam combination being used by a network-side device to configure the first beam combination.

The apparatus provided in this embodiment of this application can implement the processes implemented in the method embodiment in FIG. 8 and achieve a same technical effect. To avoid repetition, details are not described herein again.

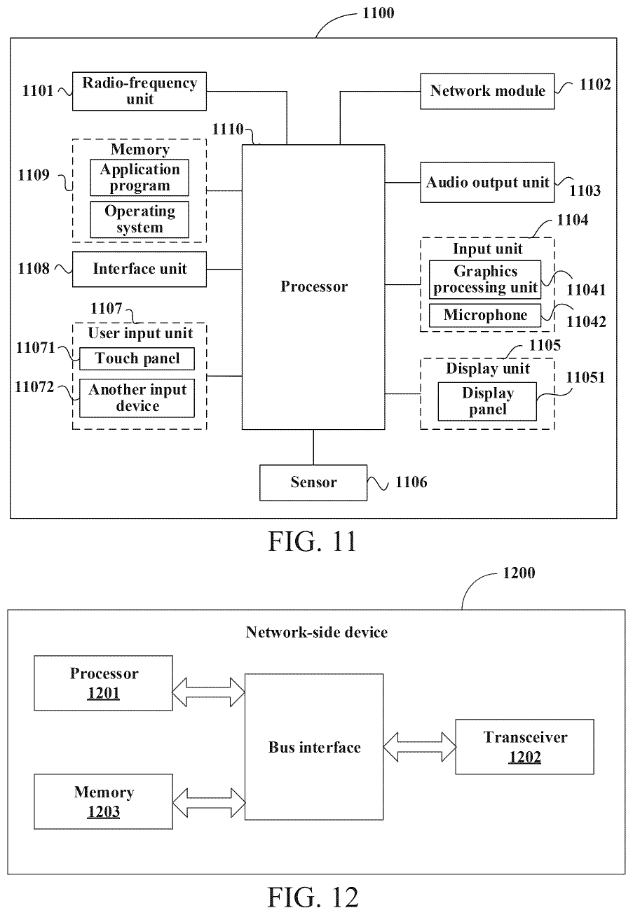

FIG. 11 is a schematic diagram of a hardware structure of a terminal that implements embodiments of this application. A terminal 1100 includes, but is not limited to, at least some components in a radio-frequency unit 1101, a network module 1102, an audio output unit 1103, an input unit 1104, a sensor 1105, a display unit 1106, a user input unit 1107, an interface unit 1108, a memory 1109, a processor 1110, and the like.

A person skilled in the art may understand that the terminal 1100 further includes a power supply (such as a battery) for supplying power to the components. The power supply may logically connect to the processor 1110 by using a power supply management system, thereby implementing functions, such as charging, discharging, and power consumption management, by using the power supply management system. A terminal structure shown in FIG. 11 does not constitute a limitation on the terminal, and the terminal may include more or fewer components than those shown in the figure, or some components may be combined, or a different component deployment may be used. Details are not described herein again.

It should be understood that, in this embodiment of this application, the input unit 1104 may include a Graphics Processing Unit (GPU) 11041 and a microphone 11042. The graphics processing unit 11041 processes image data of still pictures or videos captured by an image capture apparatus (such as a camera) in a video capture mode or an image capture mode. The display unit 1106 may include a display panel 11061. The display panel 11061 may be configured in a form of a liquid crystal display, an organic light-emitting diode, or the like. The user input unit 1107 includes at least one of a touch panel 11071 or another input device 11072. The touch panel 11071 is also referred to as a touchscreen. The touch panel 11071 may include two parts: a touch detection apparatus and a touch controller. The another input device 11072 may include, but is not limited to, a physical keyboard, a functional key (such as a volume control key or a switch key), a track ball, a mouse, and a joystick. Details are not described herein again.

In this embodiment of this application, after receiving downlink data from a network-side device, the radio-frequency unit 1101 may transmit the downlink data to the processor 1110 for processing. In addition, the radio-frequency unit 1101 may send uplink data to the network-side device. Generally, the radio-frequency unit 1101 includes, but is not limited to, an antenna, an amplifier, a transceiver, a coupler, a low noise amplifier, a duplexer, and the like.

The memory 1109 may be configured to store a software program or instruction and various data. The memory 1109 may mainly include a first storage region for storing a program or instructions and a second storage region for storing data. The first storage region may store an operating system, an application program or instructions required by at least one function (such as a sound playback function and an image playback function), and the like. In addition, the memory 1109 may include a volatile memory or a non-volatile memory, or the memory 1109 may include both the volatile memory and the non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in this embodiment of this application includes, but is not limited to, these and any other suitable types of memories.

The processor 1110 may include one or more processing units. In some embodiments, the processor 1110 integrates an application processor and a modem processor. The application processor mainly processes operations related to an operating system, a user interface, and an application program. The modem processor mainly processes a wireless communication signal, such as a baseband processor. It may be understood that the foregoing modem may not be integrated into the processor 1110.

The terminal provided in this embodiment of this application can implement the various processes implemented in the method embodiment in FIG. 7 and achieve a same technical effect. To avoid repetition, details are not described herein again.

Referring to FIG. 12, FIG. 12 is a structural diagram of a network-side device to which embodiments of the present application are applied. As shown in FIG. 12, a communication device 1200 includes: a processor 1201, a transceiver 1202, a memory 1203, and a bus interface, where the processor 1201 may be responsible for managing a bus architecture and general processing. The memory 1203 may store data used by the processor 1201 when the processor performs an operation.

In an embodiment of the present application, the communication device 1200 further includes: a program that is stored in the memory 1203 and that can be run on the processor 1201. When the program is executed by the processor 1201, steps of the foregoing method in FIG. 8 are implemented.

In FIG. 12, the bus architecture may include any quantity of interconnected buses and bridges, and links together circuits that are of one or more processors represented by the processor 1201 and of a memory represented by the memory 1203. The bus architecture may further link various other circuits together such as a peripheral device, a voltage regulator, and a power management circuit. These are all well-known in the art, and therefore are not further described herein. The bus interface provides an interface. The transceiver 1202 may be a plurality of elements, including a transmitter and a receiver, and providing units for communicating with various other apparatuses on a transmission medium.

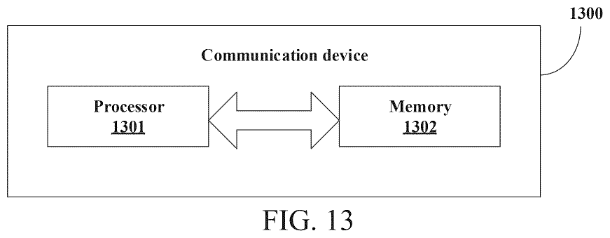

As shown in FIG. 13, an embodiment of this application further provides a communication device 1300, including a processor 1301 and a memory 1302. The memory 1302 stores a program or an instruction that can be run on the processor 1301. For example, when the communication device 1300 is a terminal, the program or the instruction is executed by the processor 1301 to implement the steps of the foregoing method embodiment in FIG. 7. When the communication device 1300 is a network-side device, the program or the instruction is executed by the processor 1301 to implement the steps of the foregoing method embodiment in FIG. 8, and a same technical effect can be achieved. To avoid repetition, details are not described herein again.

An embodiment of this application further provides a readable storage medium. The readable storage medium has a program or an instruction stored therein, and when the program or the instruction is executed by a processor, the processes in the method in FIG. 7 or FIG. 8 and the foregoing embodiments are implemented, and a same technical effect can be achieved. To avoid repetition, details are not described herein again.

The processor may be a processor in the terminal in foregoing embodiments. The readable storage medium includes a computer-readable storage medium, for example, a computer read only memory ROM, a random-access memory RAM, a magnetic disk, an optical disk, and the like.

An embodiment of this application further provides a chip. The chip includes a processor and a communication interface, the communication interface is coupled to the processor, and the processor is configured to run a program or an instruction to implement the processes shown in FIG. 7 or FIG. 8 and the foregoing method embodiments, and a same technical effect can be achieved. To avoid repetition, details are not described herein again.

It will be appreciated that the chip as referred to in this embodiment of this application may also be referred to as a system on chip, a system chip, a chip system, a system-on-chip, or the like.

An embodiment of this application also provides a computer program/program product. The computer program/program product is stored in a storage medium, the computer program/program product is executed by at least one processor to implement the processes shown in FIG. 7 or FIG. 8 and the foregoing method embodiments, and a same technical effect can be achieved. To avoid repetition, details are not described herein again.

An embodiment of this application further provides a communication system, where the communication system includes a terminal and a network-side device. The terminal is configured to perform the processes in FIG. 7 and the foregoing method embodiments, the network-side device is configured to perform the processes in FIG. 8 and the foregoing method embodiments, and a same technical effect can be achieved. To avoid repetition, details are not described herein again.

It is to be noted that, the terms “include”, “comprise”, or any other variations thereof herein are intended to cover a non-exclusive inclusion, such that a process, method, article, or apparatus including a series of elements not only includes those elements, but also includes other elements that are not explicitly listed, or also includes elements inherent to such a process, method, article, or apparatus. Without more restrictions, the elements defined by the sentence “including/comprising a/an . . . ” do not exclude existence of other identical elements in the process, the method, the article, or the apparatus including the elements. Moreover, it should be noted that the scope of the method and the apparatus in the implementations of this application is not limited to performing functions in the order shown or discussed, and may also include performing functions in a substantially concurrent manner or in reverse order depending on the functionality involved. For example, the method described may be performed in an order different from that described, and various steps may also be added, omitted, or combined. Moreover, features described with reference to some examples may be combined in other examples.

According to the descriptions in the foregoing implementations, a person skilled in the art may clearly learn that the method according to the foregoing embodiments may be implemented by software plus a necessary universal hardware platform, and may also be implemented by hardware. Based on such understanding, the technical solution of this application, in essence or the part that makes contributions to the prior art, may be embodied in a form of a computer software product. The computer software product is stored in a storage medium (such as an ROM/RAM, a magnetic disk, or an optical disk) and includes several instructions for enabling a terminal (which may be a mobile phone, a computer, a server, an air conditioner, a network device, or the like) to execute the method according to the embodiments of this application.

The embodiments of this application are described above with reference to the accompanying drawings. However, this application is not limited to the foregoing specific implementations. The foregoing specific implementations are only illustrative rather than restrictive. Inspired by this application, a person of ordinary skill in the art can still make many forms without departing from the essence of this application and the protection scope of the claims, all of which fall within the protection of this application.

What is claimed is:

1. A method for beam report sending, comprising:
sending, by a terminal, a beam report, the beam report comprising or being associated with beam combination indication information, the beam combination indication information being used for indicating a target beam combination, and the target beam combination being used for determining at least one of beam quality information, beam information, or artificial intelligence (AI) model monitoring information that are fed back by the beam report.

2. The method according to claim 1, further comprising:
acquiring, by the terminal, a first beam combination, the first beam combination comprising M beam combinations or N activated beam combinations, M being an integer greater than or equal to 1, and N being an integer greater than or equal to 0.

3. The method according to claim 2, further comprising:
sending, by the terminal, information of a second beam combination, the second beam combination satisfying one of the following:
the first beam combination being a subset of the second beam combination;
some beam combinations in the second beam combination being the same as some beam combinations in the first beam combination; or
the second beam combination being used by a network-side device to configure the first beam combination.

4. The method according to claim 2, wherein the acquiring, by the terminal, a first beam combination comprises at least one of the following:
acquiring, by the terminal, configuration information of the beam report, the configuration information being associated with or comprising the first beam combination; or
receiving, by the terminal, first information, the first information being associated with or comprising the first beam combination, and the first information being information other than the configuration information of the beam report.

5. The method according to claim 4, wherein:
the configuration information being associated with or comprising the first beam combination comprises: the configuration information being associated with or comprising a complete set of the first beam combination; or
the first information being associated with or comprising the first beam combination comprises: the first information being associated with or comprising the complete set of the first beam combination.

6. The method according to claim 2, further comprising:
receiving, by the terminal, second information,
wherein the second information is used for at least one of the following:
activating or deactivating at least some beam combinations in the first beam combination; or
activating or deactivating some beam information and/or beam resources in at least some beam combinations in the first beam combination.

7. The method according to claim 6, wherein an overhead of information used for activating or deactivating a beam combination in the second information is determined by M or N.

8. The method according to claim 6, wherein the second information comprises M or N.

9. The method according to claim 2, wherein when configuration information of the beam report is associated with an aperiodic time-domain characteristic, the configuration information of the beam report is associated with a first trigger state, the first trigger state being associated with one or more beam combinations in the first beam combination, and the one or more beam combinations being simultaneously activated when the first trigger state is triggered.

10. The method according to claim 2, wherein an overhead of the beam combination indication information is determined by M or N.

11. The method according to claim 1, wherein the beam report satisfies one of the following:
the beam report comprising or being associated with one piece of beam combination indication information, the one piece of beam combination indication information corresponding to one piece of time information or corresponding to one piece of AI model monitoring information;
the beam report comprising or being associated with a plurality of pieces of beam combination indication information, each piece of beam combination indication information corresponding to one piece of time information or corresponding to one piece of AI model monitoring information, and the time information being used for indicating a time-domain position or periodic position of the beam indication information;
the beam report comprising or being associated with one piece of beam combination indication information, the beam combination indication information comprising bitmap information, the bitmap information comprising at least one bit, and each bit corresponding to AI model monitoring information of a beam combination;
the beam report comprising or being associated with one piece of beam combination indication information, the one piece of beam combination indication information corresponding to at least one piece of AI model monitoring information;
the beam report comprising or being associated with at least one piece of beam combination indication information and at least one piece of AI model monitoring information, one piece of beam combination indication information corresponding to one piece of AI model monitoring information;
the beam report comprising or being associated with at least one piece of AI model monitoring information, one piece of AI model monitoring information corresponding to one or more pieces of beam combination indication information; or
the beam report comprising bitmap information, the bitmap information comprising at least one bit, and each bit corresponding to one piece of beam indication information,
wherein the AI model monitoring information is used for indicating overall performance of one or more beam combinations indicated by one or more pieces of beam combination indication information associated therewith.

12. The method according to claim 2, wherein the beam report does not comprise the beam combination indication information when M or N is equal to 1.

13. The method according to claim 2, further comprising:
performing, by the terminal, beam measurement on a target beam combination, the target beam combination being a complete set of the first beam combination.

14. The method according to claim 2, wherein at least one different beam resource or beam information exists between different beam combinations in the first beam combination.

15. A method for beam report receiving, comprising:
receiving, by a network-side device, a beam report, the beam report comprising or being associated with beam combination indication information, the beam combination indication information being used for indicating a target beam combination, and the target beam combination being used for determining at least one of beam quality information, beam information, or artificial intelligence (AI) model monitoring information that are fed back by the beam report.

16. The method according to claim 15, further comprising:
configuring, by the network-side device, a first beam combination for a terminal, the first beam combination comprising M beam combinations or N activated beam combinations, M being an integer greater than or equal to 1, and N being an integer greater than or equal to 0.

17. The method according to claim 16, further comprising:
receiving, by the network-side device, information of a second beam combination, the second beam combination satisfying one of the following:
the first beam combination being a subset of the second beam combination;
some beam combinations in the second beam combination being the same as some beam combinations in the first beam combination; or
the second beam combination being used by the network-side device to configure the first beam combination.

18. The method according to claim 16, wherein the configuring, by the network-side device, a first beam combination for a terminal comprises at least one of the following:
sending, by the network-side device, configuration information of the beam report to the terminal, the configuration information being associated with or comprising the first beam combination; or
sending, by the network-side device, first information to the terminal, the first information being associated with or comprising the first beam combination, and the first information being information other than the configuration information of the beam report.

19. The method according to claim 18, wherein:
the configuration information being associated with or comprising the first beam combination comprises: the configuration information being associated with or comprising a combined complete set of the first beam combination; or
the first information being associated with or comprising the first beam combination comprises: the first information being associated with or comprising a complete set of the first beam combination.

20. A communication device, comprising a processor and a memory storing a program or an instruction that is capable of running on the processor, wherein the program or the instruction, when executed by the processor, causes the communication device to perform operations comprising:
sending a beam report, the beam report comprising or being associated with beam combination indication information, the beam combination indication information being used for indicating a target beam combination, and the target beam combination being used for determining at least one of beam quality information, beam information, or artificial intelligence (AI) model monitoring information that are fed back by the beam report.
